(19) United States
(12) Patent Application Publication
(10) Pub. No.: US 2024/0312074 A1
(43) Pub. Date: Sep. 19, 2024

(54) IMAGE PROCESSING DEVICE AND IMAGE PROCESSING METHOD

(71) Applicant: LAPIS Technology Co., Ltd., Yokohama (JP)

(72) Inventors: Naoki NISHITANI, Yokohama (JP); Yuki IMATOH, Yokohama (JP)

(73) Assignee: LAPIS Technology Co., Ltd., Yokohama (JP)

(21) Appl. No.: 18/603,175

(22) Filed: Mar. 12, 2024

(30) Foreign Application Priority Data
Mar. 14, 2023 (JP) 2023-040171

(51) Int. Cl. G06T 11/00; G06T 5/70; G06V 10/56; G06V 10/60; G06V 10/75

(52) U.S. Cl. CPC G06T 11/001; G06T 5/70; G06V 10/56; G06V 10/60; G06V 10/751; G06T 2207/10024

(57) ABSTRACT

An image processing device generates a brightness image and a color difference image by calculating a brightness value and color difference values for one pixel from multiple pixels within a first range in an image photographed by a single-chip image sensor, calculates a double-end brightness correlation coefficient that represents a correlation between a selected brightness pixel and other brightness pixels from the brightness values of multiple brightness pixels within a second range including the selected brightness pixel from the brightness image as well as calculating a weighting coefficient for each of the brightness pixels within the second range from the double-end brightness correlation coefficient, and corrects the color difference values of the color difference image using the weighting coefficient calculated from the brightness image.

### CROSS-REFERENCE TO RELATED APPLICATION

This application claims the priority benefits of Japanese application no. 2023-040171, filed on Mar. 14, 2023. The entirety of the above-mentioned patent application is hereby incorporated by reference herein and made a part of this specification.

### BACKGROUND

### Technical Field

The disclosure relates to an image processing device and an image processing method that perform demosaic processing.

### Description of Related Art

Patent Literature 1 (Japanese Patent Application Laid-Open No. 2014-200033) discloses an image processing device which includes a reference area setting section that sets a reference area which is a region composed of a predetermined number of pixels from a first image composed of an image signal output from a single-chip pixel section in which pixels corresponding to each of color components of RGB are regularly disposed on a plane, and changes the region of the reference area; and a direction detection section which evaluates statistics obtained from pixel values of pixels in the reference area and detects the directionality of a position of interest in the first image.

For the direction detection section of the image processing device in Patent Literature 1 detecting the directionality of the position of interest in the first image, the difference between the pixel value obtained by horizontally interpolating the pixel value of the green pixel at the position of the red pixel and blue pixel and the respective pixel values of the red pixel and the blue pixel, that is, a horizontal interpolation color difference is calculated, and the difference between the pixel value obtained by vertically interpolating the pixel value of the green pixel at the position of the red pixel and the blue pixel and the respective pixel values of the red pixel and the blue pixel, that is, a vertical interpolation color difference is calculated. Moreover, for example, the variance of the horizontal interpolation color difference and the vertical interpolation color difference is calculated for each of reference areas having a predetermined size such as 3 pixels×3 pixels, 5 pixels×5 pixels, or 7 pixels×7 pixels.

In this way, in the image processing device in Patent Literature 1, while changing the position and size of the reference area, it is needed to calculate the horizontal interpolation color difference and the vertical interpolation color difference after interpolating the pixel value of the green pixel for each of the reference areas, and calculate the variance of each of the horizontal interpolation color difference and the vertical interpolation color difference in real time. Calculating the variance tends to need a large amount of calculation, so calculating the variance in real time needs a high-performance processor, which increases the cost of the image processing device as well as the size of the image processing device.

The disclosure provides an image processing device and an image processing method that perform demosaic processing on a single-chip image sensor without calculating the variance of pixel values.

### SUMMARY

The image processing device according to the disclosure includes: an image generation section which generates a brightness image and a color difference image that correspond to an image by executing a process of calculating a brightness value and a color difference value for one pixel from multiple pixels within a first range having a predetermined size of the image photographed by a single-chip image sensor while changing a position of the first range; a coefficient calculation section which calculates a brightness correlation coefficient representing a correlation between a selected brightness pixel and other brightness pixels from brightness values of multiple brightness pixels within a predetermined second range including the selected brightness pixel selected from brightness pixels constituting the brightness image generated by the image generation section for each of the brightness pixels within the second range as well as calculating a weighting coefficient for each of the brightness pixels within the second range from the calculated brightness correlation coefficient; and a correction section which corrects a color difference value of the color difference image at a position of the selected brightness pixel using the weighting coefficient for each of the brightness pixels within the second range calculated by the coefficient calculation section and a color difference value of each of color difference pixels constituting the color difference image included in the same range as the second range.

Furthermore, the image processing method according to the disclosure includes: a computer executes a process of generating a brightness image and a color difference image that correspond to an image by executing a process of calculating a brightness value and a color difference value for one pixel from multiple pixels within a first range having a predetermined size of the image photographed by a single-chip image sensor while changing a position of the first range, calculating a brightness correlation coefficient representing a correlation between a selected brightness pixel and other brightness pixels from brightness values of multiple brightness pixels within a predetermined second range including the selected brightness pixel selected from brightness pixels constituting the brightness image generated for each of the brightness pixels within the second range as well as calculating a weighting coefficient for each of the brightness pixels within the second range from the calculated brightness correlation coefficient, and correcting a color difference value of the color difference image at a position of the selected brightness pixel using the weighting coefficient for each of the brightness pixels within the second range calculated and a color difference value of each of color difference pixels constituting the color difference image included in the same range as the second range.

### BRIEF DESCRIPTION OF THE DRAWINGS

FIG. 1 is a diagram showing an example of a functional configuration of an image processing device.

FIG. 2 is a diagram showing an example of a Bayer array.

FIG. 3 is a diagram showing an example of a main part configuration of an electrical system in an image processing device.

FIG. 4 is a flowchart showing an example of the flow of demosaic processing.

FIG. 5 is a diagram showing how a brightness image and a color difference image are generated from a Bayer image.

FIG. 6 is a diagram showing extracted pixels within a first range in a Bayer image.

FIG. 7 is a diagram showing an example of calculating a brightness correlation coefficient.

FIG. 8 is a diagram showing an example of a magnitude relationship between brightness values that adjacent pixels may take.

FIG. 9 is a diagram showing another example of a magnitude relationship between brightness values that adjacent pixels may take.

FIG. 10 is a diagram showing an example of both-end brightness correlation coefficients of a selected pixel and each of adjacent pixels.

FIG. 11 is a diagram showing an example of weighting coefficients.

FIG. 12 is a diagram showing an example of correction of color difference values.

FIG. 13 is a diagram showing an example of an image when a color difference image is not corrected.

FIG. 14 is a diagram showing an example of an image when a color difference image is corrected.

FIG. 15 is a diagram showing an example of a functional configuration of an image processing device that smoothes a color difference image.

FIG. 16 is a flowchart showing an example of the flow of demosaic processing for smoothing a color difference image.

FIG. 17 is a diagram showing an example of a color difference image.

FIG. 18 is a diagram showing an example of an image obtained by smoothing a color difference image.

### DESCRIPTION OF THE EMBODIMENTS

According to the disclosure, demosaic processing may be performed on a single-chip image sensor without calculating the variance of pixel values.

Hereinafter, embodiments will be described with reference to the drawings. Note that the same components and the same processes are given the same reference numerals throughout all the drawings, and redundant descriptions will be omitted.

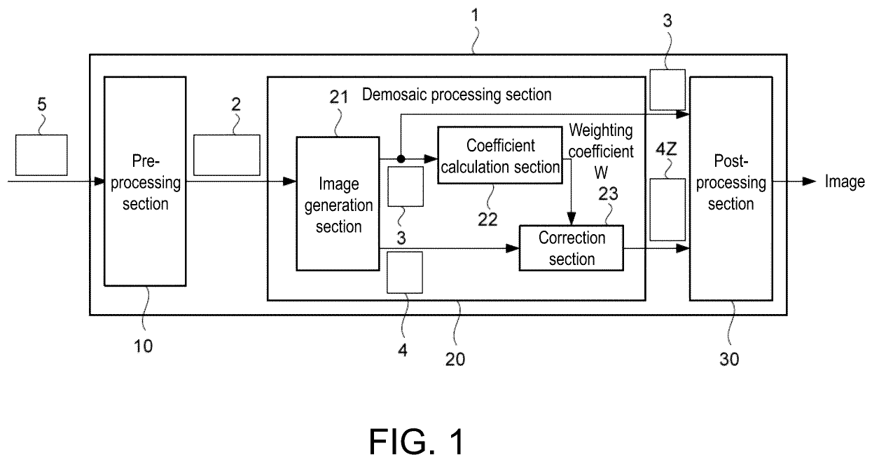

FIG. 1 is a diagram showing an example of a functional configuration of an image processing device 1 according to the embodiment. The image processing device 1 includes a pre-processing section 10, a demosaic processing section 20, and a post-processing section 30.

The pre-processing section 10 receives a sensor image 5 from a single-chip image sensor, and performs pre-processing, such as defective pixel correction, black level adjustment, and white balance, on the received sensor image 5. The pre-processing section 10 outputs the pre-processed sensor image 5 to the demosaic processing section 20 as a Bayer image 2.

The single-chip image sensor outputs the sensor image 5 in which each of pixels has color information of merely one of the three primary colors of red light, green light, and blue light. Therefore, the disposition of the pixels in the sensor image 5 output from the single-chip image sensor uses a Bayer array.

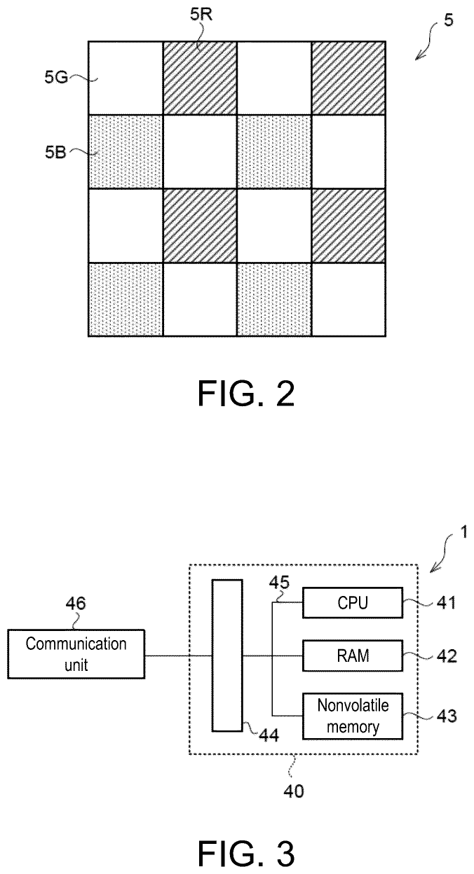

FIG. 2 is a diagram showing an example of a Bayer array. In the Bayer array, green pixels 5G are disposed every other row so that the positions of the green pixels 5G in one row and the positions of the green pixels 5G in another row are not adjacent to each other in a column direction in adjacent rows, and red pixels 5R and blue pixels 5B are alternately disposed row by row between the green pixels 5G.

The array of pixels in the Bayer image 2 is also a Bayer array. Therefore, the demosaic processing section 20 performs demosaic processing to interpolate missing color information at a specific position of the Bayer image 2 to generate a color image and generate a brightness image 3 and a color difference image 4.

The demosaic processing section 20 which performs such processing includes an image generation section 21, a coefficient calculation section 22, and a correction section 23.

The image generation section 21 generates the brightness image 3 and the color difference image 4 that correspond to the Bayer image 2 by executing a process of calculating a brightness value and a color difference value for one pixel from multiple pixels within a first range having a predetermined size set in the Bayer image 2 while changing a position of the first range.

The coefficient calculation section 22 calculates a brightness correlation coefficient representing a correlation between a selected brightness pixel and other brightness pixels from brightness values of multiple brightness pixels within a predetermined second range including the selected brightness pixel selected from brightness pixels constituting the brightness image 3 generated by the image generation section 21 for each of the brightness pixels within the second range as well as calculating a weighting coefficient W for each of the brightness pixels within the second range from the calculated brightness correlation coefficient.

The correction section 23 corrects a color difference value of the color difference image 4 generated by the image generation section 21 using the weighting coefficient W for each of the brightness pixels within the second range calculated by the coefficient calculation section 22 and a color difference value of each of color difference pixels constituting the color difference image 4 included in the same range as the second range.

The post-processing section 30 receives the brightness image 3 generated by the demosaic processing section 20 and the color difference image 4 that is corrected (hereinafter referred to as “corrected color difference image 4Z”), and performs image processing such as edge enhancement and hue adjustment on an image represented by the brightness image 3 and the corrected color difference image 4Z.

The image processing device 1 which performs such processing is configured using a computer 40. FIG. 3 is a diagram showing an example of a main part configuration of an electrical system in the image processing device 1 configured using the computer 40.

The computer 40 includes a central processing unit (CPU) 41, which is an example of a processor that handles processing of each of the functional sections shown in FIG. 1 included in the image processing device 1; a random access memory (RAM) 42 used as a temporary work area of the CPU 41; a nonvolatile memory 43; and an input/output interface (I/O) 44. The CPU 41, the RAM 42, the nonvolatile memory 43, and the I/O 44 are each connected via a bus 45.

The nonvolatile memory 43 is an example of a storage device which maintains stored information even if the power supplied to the nonvolatile memory 43 is cut off, for example, a semiconductor memory is used, but a hard disk may also be used. The nonvolatile memory 43 stores, for example, an image processing program which causes the computer 40 to function as the image processing device 1.

The nonvolatile memory 43 does not need to be built into the computer 40, and may be a portable storage device, such as a memory card, that may be attached to and detached from the computer 40.

A communication unit 46 which communicates with an external device via a communication line is connected to the I/O 44, for example, but units connected to the I/O 44 are not limited thereto, and units corresponding to the functions provided in the image processing device 1 may be connected to the I/O 44.

Next, the processing of the demosaic processing section 20 in the image processing device 1 shown in FIG. 1 will be described in detail.

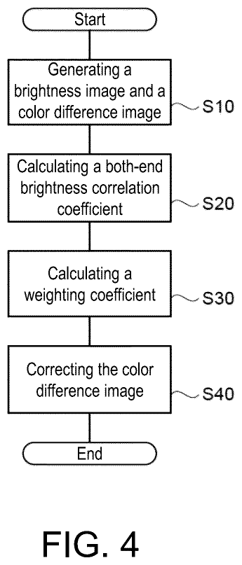

FIG. 4 is a flowchart showing an example of the flow of demosaic processing performed by the demosaic processing section 20 when the Bayer image 2 is received from the pre-processing section 10. The CPU 41 of the image processing device 1 reads an image processing program from the nonvolatile memory 43 and executes demosaic processing.

In step S10, the image generation section 21 sets a range including two pixels each in a row direction and the column direction of the Bayer image 2 as a first range, and calculates a brightness value and a color difference value for one pixel from each of pixels included in the first range. The image generation section 21 generates the brightness image 3 and the color difference image 4 by moving the first range set in the Bayer image 2 pixel by pixel in the row direction or the column direction.

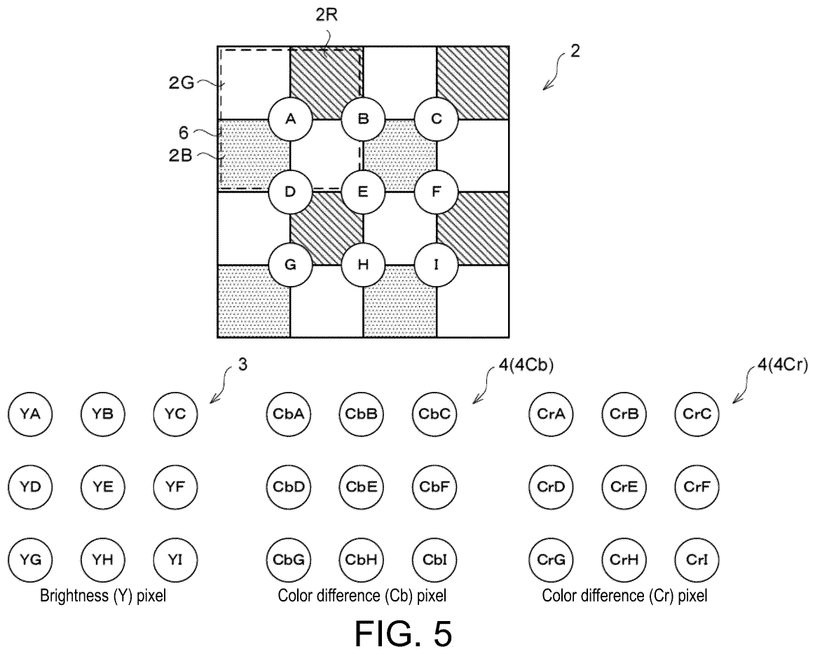

FIG. 5 is a diagram showing how the brightness image 3 and the color difference image 4 are generated from the Bayer image 2. Here, an example will be described in which the brightness image 3 and the color difference image 4 are generated using the Bayer image 2 having a size of 4×4 pixels in which four pixels are arranged in each of the row direction and the column direction, but the Bayer image 2 may be larger than 4×4 pixels in size. Note that among the pixels constituting the Bayer image 2, a green pixel, a red pixel, and a blue pixel are represented as a green pixel 2G, a red pixel 2R, and a blue pixel 2B, respectively.

First, the image generation section 21 assigns a new pixel to a position where the vertex of each of the pixels within the first range represented by a frame 6 overlaps (referred to as “position A”), and calculates a brightness value and a color difference value of the pixel from four pixels within the first range. That is, the image generation section 21 uses four pixels included in the Bayer image 2 to generate one pixel that constitutes each of the brightness image 3 and the color difference image 4. Note that the pixels that constitutes the brightness image 3 are examples of brightness pixels, and the pixels that constitutes the color difference image 4 are examples of color difference pixels.

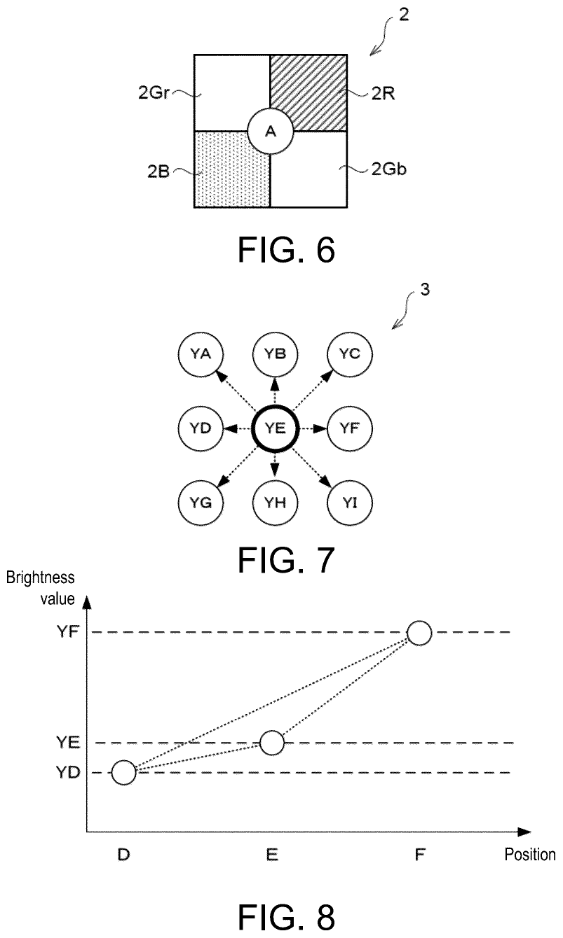

FIG. 6 is a diagram in which pixels within the first range represented by the frame 6 are extracted from the Bayer image 2 shown in FIG. 5. Since the pixels of the Bayer image 2 are arranged according to the Bayer array, as shown in FIG. 6, the first range includes two green pixels 2G, one red pixel 2R, and one blue pixel 2B. In FIG. 6, in order to distinguish between the two green pixels 2G, one green pixel 2G is expressed as “green pixel 2Gr”, and the other green pixel 2G is expressed as “green pixel 2Gb”. Note that either of the two green pixels 2G may be the green pixel 2Gr.

The image generation section 21 calculates the brightness value and the color difference value at the position A using Formula (1).

$$\begin{matrix}[ Formula 1 ] & \\ \begin{matrix}Y = ( 0.587 ( ( ZGr + ZGb ) / 2 ) ) + 0.2 \; 99 ZR + 0. 114 ZB \\ Cb = 0. 564 ( ZB - Y ) \\ Cr = 0.713 ( ZR - Y )\end{matrix} \} & ( 1 )\end{matrix}$$

In Formula (1), Y represents the brightness value, Cb represents a blue color difference value, Cr represents a red color difference value, ZGr represents the pixel value of the green pixel 2Gr, ZGb represents the pixel value of the green pixel 2Gb, ZR represents the pixel value of the red pixel 2R, and ZB represents the pixel value of the blue pixel 2B.

Note that Formula (1) is an example of calculating the brightness value and the color difference value, and the image generation section 21 may calculate the brightness value and the color difference value using other calculation formulas that comply with the Bayer image 2 standard. Further, the image generation section 21 may calculate the brightness value and the color difference value using a simplified formula with lower calculation accuracy than Formula (1).

Hereinafter, the brightness value at each of positions will be expressed by combining the alphabet representing the position and “Y” representing the brightness value. Specifically, for example, the brightness value at the position A is expressed as “YA”. When expressing the brightness value with particular consideration to the position is not needed, the brightness value at each of the positions is collectively referred to as the brightness value Y.

In addition, the blue color difference value at each of the positions is expressed by combining the alphabet representing the position and “Cb” representing the blue color difference value, and the red color difference value at each of the positions is expressed by combining the alphabet representing the position and “Cr” representing the red color difference value. Specifically, for example, the blue color difference value at the position A is expressed as “CbA”, and the red color difference value at the position A is expressed as “CrA”. When expressing the color difference value with particular consideration to the position is not needed, the blue color difference value and the red color difference value at each of the positions are collectively referred to as the color difference value Cb and the color difference value Cr, respectively.

The image generation section 21 moves the first range set in the Bayer image 2 one pixel at a time in the row direction or the column direction, and calculates the brightness value Y and the color difference values Cb and Cr at the position A to position I shown in FIG. 5. In this way, the image generation section 21 generates the brightness image 3 and the color difference image 4. The image generation section 21 outputs the generated brightness image 3 to the post-processing section 30 and the coefficient calculation section 22, and outputs the generated color difference image 4 to the correction section 23.

Note that the color difference image 4 composed of pixels having the color difference value Cb is particularly expressed as a color difference image 4Cb, the color difference image 4 composed of pixels having the color difference value Cr is particularly referred to as a color difference image 4Cr.

After generation of the brightness image 3 and the color difference images 4Cb and 4Cr from the Bayer image 2, in step S20 of FIG. 4, the coefficient calculation section 22 sequentially selects one pixel at a time from the brightness image 3 generated in the process of step S10. For each of selected pixels, the coefficient calculation section 22 sets a second range centered on the pixel, and calculates a brightness correlation coefficient representing the correlation between the selected pixel and each of the other pixels included in the second range. The pixels selected from the brightness image 3 are an example of selected brightness pixels.

Note that the coefficient calculation section 22 sets a range including each of pixels adjacent to the selected pixel as the second range.

FIG. 7 is a diagram showing an example of calculating a brightness correlation coefficient. The example in FIG. 7 shows that a pixel at position E surrounded by a thick frame is selected from the brightness image 3. In this case, the pixels adjacent to the pixel at the position E are the pixels at the position A, position B, position C, position D, position F, position G, position H, and the position I, so a range including pixels from the position A to the position I is set as the second range.

Within the second range, the coefficient calculation section 22 calculates, with the selected pixel (in this case, the pixel at the position E) as the center, a brightness correlation coefficient using the brightness values Y of the pixels at both ends located in each of the vertical direction, the horizontal direction, and a diagonal direction. The brightness correlation coefficient is a brightness correlation coefficient using the brightness values Y of pixels located at both ends of the selected pixel in the vertical direction, the horizontal direction, and the diagonal direction, so hereinafter, the brightness correlation coefficient will be expressed as “both-end brightness correlation coefficient X.”

In FIG. 7, the pixels at both ends of the pixel at the position E in the horizontal direction are the pixel at the position D and the pixel at the position F. The coefficient calculation section 22 calculates the both-end brightness correlation coefficients X of the pixel at the position E and the pixels at both ends located in the horizontal direction using Formula (2).

$$\begin{matrix}[ Formula 2 ] & \\ \begin{matrix}XF = \frac{\vert YD - YE \vert}{\vert YD - YF \vert} \\ XD = 1 - XF\end{matrix} \} & ( 2 )\end{matrix}$$

In Formula (2), XF represents the both-end brightness correlation coefficient X with the pixel at the position F, and XD represents the both-end brightness correlation coefficient X with the pixel at the position D. Hereinafter, the both-end brightness correlation coefficient X at each of the positions from the position A to the position I will be expressed as described above by combining the alphabet representing the position and “X” representing the both-end brightness correlation coefficient.

Similarly, the coefficient calculation section 22 uses Formula (3), Formula (4), and Formula (5) to calculate the both-end brightness correlation coefficients X of the pixel at the position E and the pixels at both ends located in the vertical direction and the diagonal direction. Formula (3) is a formula for calculating the both-end brightness correlation coefficients X of the pixel at the position E and the pixels at both ends located in the vertical direction. Formula (4) is a formula for calculating the both-end brightness correlation coefficients X of the pixel at the position E and the pixels at both ends located diagonally to the left. Formula (5) is a formula for calculating the both-end brightness correlation coefficients X of the pixel at the position E and the pixels at both ends located diagonally to the right.

$$\begin{matrix}[ Formula 3 ] & \\ XH = \frac{\vert YB - YE \vert}{\vert YB - YH \vert} XB = 1 - XH & ( 3 )\end{matrix}$$

$$\begin{matrix}[ Formula 4 ] & \\ Xl = \frac{\vert YA - YE \vert}{\vert YA - YI \vert} XA = 1 - XI & ( 4 )\end{matrix}$$

$$\begin{matrix}[ Formula 5 ] & \\ XC = \frac{\vert YG - YE \vert}{\vert YG - YC \vert} XG = 1 - XC & ( 5 )\end{matrix}$$

As can be seen from Formula (2) to Formula (5), the coefficient calculation section 22 expresses the both-end brightness correlation coefficient X as a normalized value of 0 or more and 1 or less. Then, the coefficient calculation section 22 expresses the both-end brightness correlation coefficient X by the closest value among a predetermined number of values set in the range of 0 to 1. As an example, the coefficient calculation section 22 sets the possible value of the both-end brightness correlation coefficient X to θ/8 (θ is an integer between 0 and 8), so that the values that the both-end brightness correlation coefficient X may take are aggregated into nine values within the range of 0 or more and 1 or less. Note that the value of the denominator of the both-end brightness correlation coefficient X is an example, and is not limited to “8”. By aggregating the values that the two-end brightness correlation coefficient X may take, the calculation content can be made simpler than when the two-end brightness correlation coefficient X takes any value between 0 and 1.

As shown in FIG. 8, for example, when a brightness value YE of the pixel at the position E in the brightness image 3 is included between a brightness value YD and a brightness value YF of the pixels at both ends located in the horizontal direction, that is, when the brightness value YF>the brightness value YE>the brightness value YD, or the brightness value YD>the brightness value YE>the brightness value YF, the both-end brightness correlation coefficient X obtained by Formula (2) is 1 or less, and the closest value is taken among θ/8.

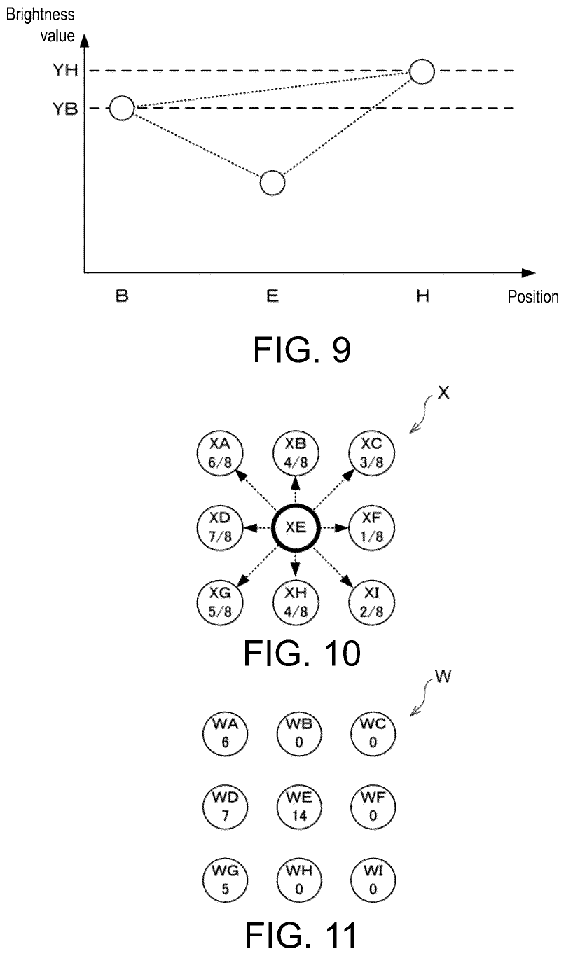

However, as shown in FIG. 9, for example, if the brightness value YE of the pixel at the position E in the brightness image 3 is not included between a brightness value YB and a brightness value YH of the pixels at both ends located in the vertical direction, the both-end brightness correlation coefficient X obtained by Formula (3) may exceed 1. In such a case, the coefficient calculation section 22 sets the both-end brightness correlation coefficient X to half the maximum value of θ/8, that is, 4/8.

FIG. 10 is a diagram showing an example of the both-end brightness correlation coefficients X of the pixel at the selected position E and the adjacent pixels, calculated according to Formula (2) to Formula (5).

The coefficient calculation section 22 selects each of the pixels included in the brightness image 3 to calculate the both-end brightness correlation coefficient X within the second range for each of the pixels.

Note that nine pixels may not be included in the second range depending on the position of the selected pixel. In such a case, the coefficient calculation section 22 may set the brightness value Y of a non-existing pixel to a predetermined value. For example, the brightness value Y of the non-existing pixel is set to “0” or the brightness value Y of the selected pixel (in the case of the example shown in FIG. 7, the pixel at the position E).

After calculating the both-end brightness correlation coefficient X at each of the pixels from the brightness image 3, in step S30 of FIG. 4, the coefficient calculation section 22 uses the calculated both-end brightness correlation coefficient X to calculate a weighting coefficient W at the position of each of the pixels within the second range for each of second ranges set for each of the pixels included in the brightness image 3.

In particular, the coefficient calculation section 22 makes the both-end brightness correlation coefficient X valid merely for pixels to which the both-end brightness correlation coefficient X exceeding a predetermined threshold value included in the range of 0.5 or more and 1 or less is associated. The weighting coefficient W in this case becomes the value of the numerator of the two-end brightness correlation coefficient X. In other words, the coefficient calculation section 22 sets the weighting coefficient W in the pixel associated with the both-end brightness correlation coefficient X that is less than or equal to the threshold value to “0”. As a result, the amount of calculation is reduced compared to the case where the weighting coefficient for the pixel associated with the both-end brightness correlation coefficient X that is equal to or less than the threshold value is also set to the value of the numerator of the both-end brightness correlation coefficient X. In the embodiment, as an example, the threshold value is set to “0.5”.

When the both-end brightness correlation coefficient X in the case of selecting the pixel at the position E in the brightness image 3 is shown as shown in FIG. 10, since the two-end brightness correlation coefficients X associated with each of the pixels at the position B, the position C, the position F, the position H, and the position I are 0.5 or less, the weighting coefficient W is “0”.

On the other hand, the weighting coefficients W of each of the pixels at the position A, the position D, and the position G to which the both-end brightness correlation coefficient X exceeding 0.5 is associated are “6”, “7”, and “5”, which are the values of the numerator of the respective both-end brightness correlation coefficients X.

FIG. 11 is a diagram showing an example of the weighting coefficient W in each of the pixels to which the both-end brightness correlation coefficient X shown in FIG. 10 is associated.

Here, for the selected pixel, since four both-end brightness correlation coefficients X, the both-end brightness correlation coefficient X in the vertical direction, the both-end brightness correlation coefficient X in the horizontal direction, the both-end brightness correlation coefficient X in the diagonal left direction, and the both-end brightness correlation coefficients X in the diagonal right direction, are calculated, the total weighting coefficient W is (8/8)×4=32/8. The coefficient calculation section 22 assigns, among “32” which is the numerator of the fraction representing the total weighting coefficient W, the value corresponding to the pixel in which the weighting coefficient W is replaced with “0” because the both-end brightness correlation coefficient X is less than or equal to the threshold value as the weighting coefficient W of the selected pixel. Therefore, in the case of the example shown in FIG. 11, the pixels associated with the weighting coefficient W exceeding 0 are the three pixels at the position A, the position D, and the position G, so the weighting coefficient W at the position E is 32−(6+7+5)=14.

In this way, the coefficient calculation section 22 calculates the weighting coefficient W for each of the pixels within the second range set for each of the pixels included in the brightness image 3.

After calculation of the weighting coefficient W for each of the second ranges from the brightness image 3, in step S40 of FIG. 4, the correction section 23 corrects the color difference values Cb and Cr of the color difference images 4Cb and 4Cr using the weighting coefficient W within the second range for each of the second ranges set for the brightness image 3 and the color difference values Cb and Cr of the pixels of the color difference image 4 included in the same range as the second range set for the brightness image 3.

Specifically, the correction section 23 selects pixels located at the same position in each of the brightness image 3 and the color difference image 4, and sets a second range including the same range for each. After that, the correction section 23 calculates the average values of the products of the weighting coefficients W and the color difference values Cb and Cr that are associated with the pixels located at the same position within the second range set for each of the brightness image 3 and the color difference image 4 as weighted average values, and sets the calculated weighted average values as the color difference values Cb and Cr of the pixels selected from the color difference image 4.

FIG. 12 is a diagram showing an example of correction of the color difference value Cr of the color difference image 4 by the correction section 23. FIG. 12 shows each of pixels within the second range that is set when the pixel at the position E is selected from the color difference image 4Cr.

When the weighting coefficients W associated with the pixels at the position A to the position I are shown as shown in FIG. 11, the correction section 23 corrects a color difference value CrE of the pixel at the position E using Formula (6).

$$\begin{matrix}[ Formula 6 ] & \\ \begin{matrix}{CrE}_{sum} = {\sum }_{μ = A}^{1} ( Cr μ * W μ \\ {CrE}_{z} = \frac{1}{32} {CrE}_{sum}\end{matrix} \} & ( 6 )\end{matrix}$$

In Formula (6), u represents the position of the pixel, and CrEsum represents the product- sum operation value of the color difference value Cr and the weighting coefficient W at each of the positions. Further, “32” represents the value of the numerator of the fraction representing the sum of the weighting coefficients W, and CrEz represents the correction value of the color difference value CrE at the pixel at the position E.

That is, the correction section 23 corrects the color difference value Cr (in this case, the color difference value CrE) at the position of the selected pixel using the weighting coefficient W at each of the pixels within the second range to which the weighting coefficient W exceeding 0 is associated and the color difference value of the pixel at the same position as the pixel associated with the weighting coefficient W exceeding 0 among the color difference values Cr of each of pixels constituting the color difference image 4Cr included in the same range.

As shown in FIGS. 10 and 11, since σ=8 and λ=4, the correction value CrEz is expressed as in Formula (7).

$$\begin{matrix}[ Formula 7 ] & \\ {CrE}_{z} = \frac{1}{32} ( 6 CrA + 7 CrD + 5 CrG + 14 CrE ) & ( 7 )\end{matrix}$$

The correction section 23 performs the same correction as the correction performed on the pixel at the position E for each of pixels included in the color difference image 4, and generates the color difference image 4Cr in which the color difference value Cr has been corrected. Although the correction of the color difference image 4Cr has been described here as an example, the correction section 23 also performs the same correction on the color difference image 4Cb, and generates the color difference image 4Cb in which the color difference value Cb has been corrected.

In this way, the correction section 23 selects each of the pixels included in the color difference image 4, corrects the color difference values Cb and Cr using the weighting coefficient W and the color difference values Cb and Cr of the pixels within the second range set for each of the selected pixels, and generates the corrected color difference image 4Z. The correction section 23 outputs the generated corrected color difference image 4Z to the post-processing section 30.

With the above, the demosaic processing shown in FIG. 4 is completed. The post-processing section 30 uses the brightness image 3 and the corrected color difference image 4Z received from the demosaic processing section 20 to perform predetermined image processing such as contour enhancement and hue adjustment.

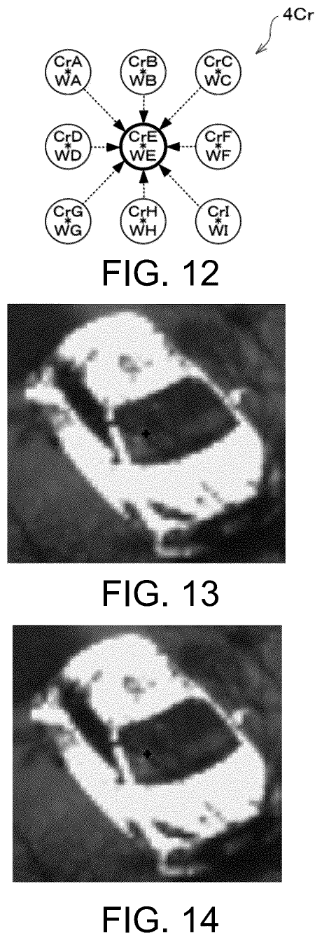

FIG. 13 is a diagram showing an example of an image expressed using the brightness image 3 and color difference image 4 generated by the image generation section 21. FIG. 14 is a diagram showing an example of an image expressed using the brightness image 3 generated by the image generation section 21 from the same image as in FIG. 13 and the corrected color difference image 4Z corrected by the correction section 23. In the image shown in FIG. 13, although pixels colored red or blue were observed near the achromatic edges, it was confirmed that the occurrence of such false colors which did not originally exist was suppressed in the image shown in FIG. 14 more than in the image shown in FIG. 13.

### Modified Example of Image Processing Device

The correction section 23 shown in FIG. 1 applied the weighting coefficient W obtained from the brightness image 3 to the color difference image 4 generated by the image generation section 21, and corrected the color difference image 4.

Hereinafter, an image processing device 1A which corrects the color difference image 4 by applying the weighting coefficient W obtained from the brightness image 3 to the color difference image 4 smoothed will be described.

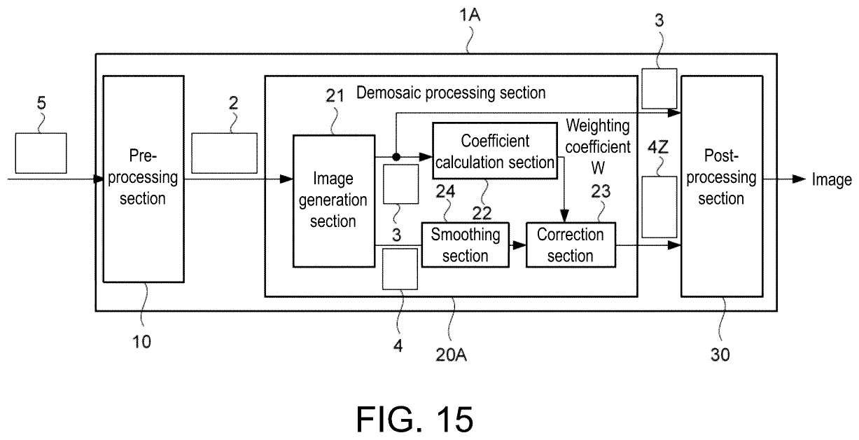

FIG. 15 is a diagram showing an example of a functional configuration of the image processing device 1A according to the modification. The image processing device 1A shown in FIG. 15 differs from the image processing device 1 shown in FIG. 1 in that a smoothing section 24 is added between the image generation section 21 and the correction section 23. Furthermore, with the addition of the smoothing section 24, the demosaic processing section 20 is replaced with a demosaic processing section 20A. Since the other functional configurations are the same as the image processing device 1 shown in FIG. 1, the processing of the smoothing section 24 will be mainly described here.

The smoothing section 24 smoothes the color difference image 4 generated by the image generation section 21 and outputs the color difference image 4 smoothed to the correction section 23. Smoothing of the color difference image 4 is a process of reducing the difference in color difference values Cb and Cr between adjacent pixels and smoothing the change in color.

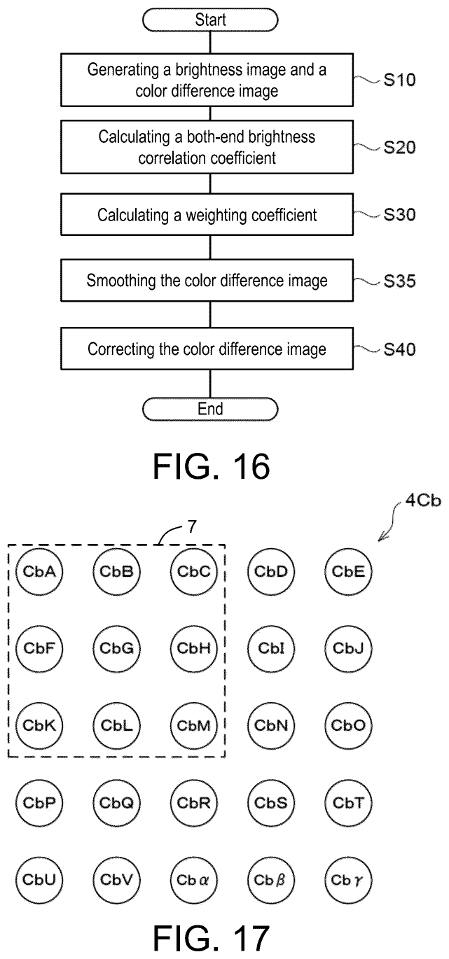

The processing of the smoothing section 24 will be described in detail. FIG. 16 is a flowchart showing an example of the flow of demosaic processing performed by the demosaic processing section 20 when the Bayer image 2 is received from the pre-processing section 10.

The demosaic processing shown in FIG. 16 differs from the demosaic processing shown in FIG. 4 in that step S35 is added.

After the coefficient calculation section 22 calculates the weighting coefficient W for each of the second ranges from the brightness image 3 in the process of step S30, step S35 is executed.

In step S35, the smoothing section 24 smoothes the color difference image 4 received from the image generation section 21.

FIG. 17 is a diagram showing an example of the color difference image 4Cb received from the image generation section 21. The smoothing section 24 selects any pixel from the color difference image 4Cb. FIG. 17 shows an example in which a pixel at the position G is selected. The smoothing section 24 sets a second range represented by a frame 7 centered on a selected pixel, that is, a second range surrounding pixels adjacent to the selected pixel to the color difference image 4Cb, and calculates the average of the color difference values Cb of each of pixels within the second range. Then, the smoothing section 24 sets the color difference value Cb of the selected pixel to the average of the calculated color difference values Cb. In the case of the example shown in FIG. 17, the average of the color difference values Cb of each of pixels at the position A, the position B, the position C, the position F, the position G, the position H, position K, position L, and position M becomes a color difference value CbG of the pixel at the position G.

The smoothing section 24 smoothes the entire color difference image 4Cb by sequentially selecting each of pixels included in the color difference image 4Cb and setting the average of the color difference values Cb of each of the pixels within the second range set for the selected pixel as the color difference value Cb of the selected pixel. The smoothing section 24 outputs the color difference image 4Cb smoothed to the correction section 23. Note that the smoothing section 24 also performs similar smoothing processing on the color difference image 4Cr.

In step S40 of FIG. 16, the correction section 23 corrects the color difference values Cb and Cr of the color difference images 4Cb and 4Cr that are smoothed using the weighting coefficient W within the second range for each of the second ranges set for the brightness image 3 and the color difference values Cb and Cr of pixels of the color difference image 4 smoothed included in the same range as the second ranges set for the brightness image 3.

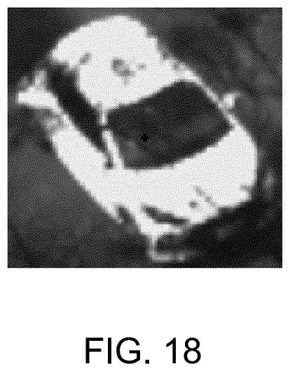

FIG. 18 is a diagram showing an example of an image expressed using the brightness image 3 generated by the image generation section 21 from the same image as in FIG. 13 and the corrected color difference image 4Z obtained by correcting the color difference image 4 smoothed by the smoothing section 24. It was confirmed that the occurrence of false colors was further suppressed by smoothing the color difference image 4 compared to the image of FIG. 14 in which the color difference image 4 was not smoothed.

Although one form of the image processing devices 1 and 1A has been described above using the embodiments, the form of the disclosed image processing devices 1 and 1A is an example, and the form of the image processing devices 1 and 1A is not limited to the scope described in the embodiments. Various changes or improvements can be made to the embodiments without departing from the gist of the disclosure, and forms with such changes or improvements are also included within the technical scope of the disclosure.

For example, the internal processing order in the demosaic processing shown in FIGS. 4 and 16 may be changed without departing from the gist of the disclosure.

In the above embodiments, as an example, a form in which demosaic processing is implemented by software has been described. However, processing equivalent to the demosaic processing flowcharts shown in FIGS. 4 and 16 may be performed by hardware. In this case, the processing speed can be increased compared to the case where the demosaic processing is implemented by software.

In the above embodiments, the processor refers to a processor in a broad sense, and

includes a general-purpose processor (for example, the CPU 41), a dedicated processor (for example, a graphics processing unit (GPU), an application specific integrated circuit (ASIC), a field programmable gate array (FPGA), a programmable logic device, etc.).

Furthermore, the operation of the processor in the above embodiments is not merely performed by one processor, and may be implemented by multiple processors located at physically separate locations working together. Further, the order of each of operations of the processor is not limited to the order described in the above embodiments, and may be changed as appropriate.

In the above embodiments, an example in which the image processing program is stored in the nonvolatile memory 43 has been described. However, the storage location of the image processing program is not limited to the nonvolatile memory 43. The image processing program of the disclosure can also be provided in a form recorded on a storage medium readable by the computer 40.

For example, the image processing program may also be provided in a form recorded on an optical disc such as a compact disk read only memory (CD-ROM), a digital versatile disk read only memory (DVD-ROM), or a Blu-ray disc. In addition, the image processing program may be provided in a form recorded in a portable semiconductor memory such as a universal serial bus (USB) memory or a memory card. The nonvolatile memory 43, the CD-ROM, the DVD-ROM, the Blu-ray disc, the USB, and the memory card are examples of non-transitory storage media.

Furthermore, the image processing device 1 may download an image processing program from an external device connected to a communication line through the communication section 46, and store the downloaded image processing program in the nonvolatile memory 43 of the image processing device 1. In this case, the CPU 41 of the image processing device 1 reads the image processing program downloaded from the external device from the nonvolatile memory 43 and executes the demosaic processing.

Additional notes related to the embodiments are shown below.

### Note 1

An image processing device includes:
an image generation section which generates a brightness image and a color difference image that correspond to an image by executing a process of calculating a brightness value and a color difference value for one pixel from multiple pixels within a first range having a predetermined size of the image photographed by a single-chip image sensor while changing a position of the first range;
a coefficient calculation section which calculates a brightness correlation coefficient representing a correlation between a selected brightness pixel and other brightness pixels from brightness values of multiple brightness pixels within a second range predetermined including the selected brightness pixel selected from brightness pixels constituting the brightness image generated by the image generation section for each of the brightness pixels within the second range as well as calculating a weighting coefficient for each of the brightness pixels within the second range from the brightness correlation coefficient calculated; and
a correction section which corrects a color difference value of the color difference image at a position of the selected brightness pixel using the weighting coefficient for each of the brightness pixels within the second range calculated by the coefficient calculation section and a color difference value of each of color difference pixels constituting the color difference image included in the same range as the second range.

### Note 2

The image processing device according to note 1 in which the coefficient calculation section calculates the brightness correlation coefficient and the weighting coefficient by setting a range including each of brightness pixels adjacent to the selected brightness pixel as the second range.

### Note 3

The image processing device according to note 1 or note 2 in which the brightness correlation coefficient is a coefficient normalized to 0 or more and 1 or less, and is a coefficient that takes any value from a predetermined number of values set in a range of 0 or more and 1 or less, and the coefficient calculation section sets the weighting coefficient to 0 in a brightness pixel associated with the brightness correlation coefficient that is equal to or less than a predetermined threshold value and is included in a range of 0.5 or more and 1 or less.

### Note 4

The image processing device according to note 3 in which when the brightness correlation coefficient before normalization exceeds 1, the coefficient calculation section sets the brightness correlation coefficient to 0.5.

### Note 5

The image processing device according to note 4 in which the correction section corrects the color difference value of the color difference image at the position of the selected brightness pixel using the weighting coefficient for each of the brightness pixels within the second range to which the weighting coefficient exceeding 0 is associated, and the color difference value of the color difference pixel located at the same position as the brightness pixel associated with the weighting coefficient exceeding 0 among the color difference values of each of the color difference pixels constituting the color difference image included in the same range as the second range.

### Note 6

The image processing device according to any one of notes 1 to 5 further includes a smoothing section which smoothes the color difference image by executing a process of setting an average of the color difference values of each of the color difference pixels within the second range as a color difference value of a selected color difference pixel using the color difference value of each of the color difference pixels within the second range including the selected color difference pixel selected from the color difference pixels constituting the color difference image while changing the selected color difference pixel.

### Note 7

An image processing method includes: a computer executes a process of generating a brightness image and a color difference image that correspond to an image by executing a process of calculating a brightness value and a color difference value for one pixel from multiple pixels within a first range having a predetermined size of the image photographed by a single-chip image sensor while changing a position of the first range,
calculating a brightness correlation coefficient representing a correlation between a selected brightness pixel and other brightness pixels from brightness values of multiple brightness pixels within a second range predetermined including the selected brightness pixel selected from brightness pixels constituting the brightness image generated for each of the brightness pixels within the second range as well as calculating a weighting coefficient for each of the brightness pixels within the second range from the brightness correlation coefficient calculated, and
correcting a color difference value of the color difference image at a position of the selected brightness pixel using the weighting coefficient for each of the brightness pixels within the second range calculated and a color difference value of each of color difference pixels constituting the color difference image included in the same range as the second range.

### Note 8

An image processing program includes: a computer is made to execute a process of generating a brightness image and a color difference image that correspond to an image by executing a process of calculating a brightness value and a color difference value for one pixel from multiple pixels within a first range having a predetermined size of the image photographed by a single-chip image sensor while changing a position of the first range,
calculating a brightness correlation coefficient representing a correlation between a selected brightness pixel and other brightness pixels from brightness values of multiple brightness pixels within a second range predetermined including the selected brightness pixel selected from brightness pixels constituting the brightness image generated for each of the brightness pixels within the second range as well as calculating a weighting coefficient for each of the brightness pixels within the second range from the brightness correlation coefficient calculated, and
correcting a color difference value of the color difference image at a position of the selected brightness pixel using the weighting coefficient for each of the brightness pixels within the second range calculated and a color difference value of each of color difference pixels constituting the color difference image included in the same range as the second range.

What is claimed is:

1. An image processing device, comprising:
an image generation section, generating a brightness image and a color difference image that correspond to an image by executing a process of calculating a brightness value and a color difference value for one pixel from a plurality of pixels within a first range having a predetermined size of the image photographed by a single-chip image sensor while changing a position of the first range;
a coefficient calculation section, calculating a brightness correlation coefficient representing a correlation between a selected brightness pixel and other brightness pixels from brightness values of a plurality of brightness pixels within a second range predetermined comprising the selected brightness pixel selected from brightness pixels constituting the brightness image generated by the image generation section for each of the brightness pixels within the second range as well as calculating a weighting coefficient for each of the brightness pixels within the second range from the brightness correlation coefficient calculated; and
a correction section, correcting a color difference value of the color difference image at a position of the selected brightness pixel using the weighting coefficient for each of the brightness pixels within the second range calculated by the coefficient calculation section and a color difference value of each of color difference pixels constituting the color difference image comprised in the same range as the second range.

2. The image processing device according to claim 1, wherein
the coefficient calculation section calculates the brightness correlation coefficient and the weighting coefficient by setting a range comprising each of brightness pixels adjacent to the selected brightness pixel as the second range.

3. The image processing device according to claim 2, wherein
the brightness correlation coefficient is a coefficient normalized to 0 or more and 1 or less, and is a coefficient that takes any value from a predetermined number of values set in a range of 0 or more and 1 or less, and
the coefficient calculation section sets the weighting coefficient to 0 in a brightness pixel associated with the brightness correlation coefficient that is equal to or less than a predetermined threshold value and is comprised in a range of 0.5 or more and 1 or less.

4. The image processing device according to claim 3, wherein
when the brightness correlation coefficient before normalization exceeds 1, the coefficient calculation section sets the brightness correlation coefficient to 0.5.

5. The image processing device according to claim 4, wherein
the correction section corrects the color difference value of the color difference image at the position of the selected brightness pixel using the weighting coefficient for each of the brightness pixels within the second range to which the weighting coefficient exceeding 0 is associated, and the color difference value of the color difference pixel located at the same position as the brightness pixel associated with the weighting coefficient exceeding 0 among the color difference values of each of the color difference pixels constituting the color difference image comprised in the same range as the second range.

6. The image processing device according to claim 1, further comprising:
a smoothing section, smoothing the color difference image by executing a process of setting an average of the color difference values of each of the color difference pixels within the second range as a color difference value of a selected color difference pixel using the color difference value of each of the color difference pixels within the second range comprising the selected color difference pixel selected from the color difference pixels constituting the color difference image while changing the selected color difference pixel.

7. The image processing device according to claim 2, further comprising:
a smoothing section, smoothing the color difference image by executing a process of setting an average of the color difference values of each of the color difference pixels within the second range as a color difference value of a selected color difference pixel using the color difference value of each of the color difference pixels within the second range comprising the selected color difference pixel selected from the color difference pixels constituting the color difference image while changing the selected color difference pixel.

8. The image processing device according to claim 3, further comprising:
a smoothing section, smoothing the color difference image by executing a process of setting an average of the color difference values of each of the color difference pixels within the second range as a color difference value of a selected color difference pixel using the color difference value of each of the color difference pixels within the second range comprising the selected color difference pixel selected from the color difference pixels constituting the color difference image while changing the selected color difference pixel.

9. The image processing device according to claim 4, further comprising:
a smoothing section, smoothing the color difference image by executing a process of setting an average of the color difference values of each of the color difference pixels within the second range as a color difference value of a selected color difference pixel using the color difference value of each of the color difference pixels within the second range comprising the selected color difference pixel selected from the color difference pixels constituting the color difference image while changing the selected color difference pixel.

10. The image processing device according to claim 5, further comprising:
a smoothing section, smoothing the color difference image by executing a process of setting an average of the color difference values of each of the color difference pixels within the second range as a color difference value of a selected color difference pixel using the color difference value of each of the color difference pixels within the second range comprising the selected color difference pixel selected from the color difference pixels constituting the color difference image while changing the selected color difference pixel.

11. An image processing method, comprising:
executing, by a computer, a process of generating a brightness image and a color difference image that correspond to an image by executing a process of calculating a brightness value and a color difference value for one pixel from a plurality of pixels within a first range having a predetermined size of the image photographed by a single-chip image sensor while changing a position of the first range,
calculating a brightness correlation coefficient representing a correlation between a selected brightness pixel and other brightness pixels from brightness values of a plurality of brightness pixels within a second range predetermined comprising the selected brightness pixel selected from brightness pixels constituting the brightness image generated for each of the brightness pixels within the second range as well as calculating a weighting coefficient for each of the brightness pixels within the second range from the brightness correlation coefficient calculated, and
correcting a color difference value of the color difference image at a position of the selected brightness pixel using the weighting coefficient for each of the brightness pixels within the second range calculated and a color difference value of each of color difference pixels constituting the color difference image comprised in the same range as the second range.
